(19) United States
(12) Patent Application Publication
(10) Pub. No.: US 2021/0240680 A1
(43) Pub. Date: Aug. 5, 2021

(54) METHOD AND SYSTEM FOR IMPROVING QUALITY OF A DATASET

(71) Applicant: Element AI Inc., Montreal (CA)

(72) Inventors: Torsten SCHOLAK, Montreal (CA); Lee ZAMPARO, Montreal (CA); Hector PALACIOS, Montreal (CA); Kamil LEGAULT, Montreal (CA); Pierre-André NOËL, Montreal (CA); Krzysztof MAJEWSKI, Montreal (CA)

(21) Appl. No.: 16/779,525

(22) Filed: Jan. 31, 2020

(51) Int. Cl. G06F 16/215; G06N 5/04

(52) U.S. Cl. CPC G06F 16/215; G06N 5/04

(57) ABSTRACT

A method and system for improving quality of a dataset for which a labeling task is to be completed. A loop is repeated comprising: inferring, for each of the labeler identifiers in the dataset, an estimated proficiency value; inferring a predicted uncertainty value of correctness of the label for at least a subset of the raw data items; and receiving a trusted evaluation value of correctness for one or more labels of the subset of the raw data items for which the predicted uncertainty is inferred. The loop is repeated until the highest predicted uncertainty value in the dataset is below a threshold value.

### TECHNICAL FIELD

The present invention relates to machine learning and, more particularly, to improving the outcome of machine learning efforts.

### BACKGROUND

Massive labelled datasets are used to train machine learning and/or deep learning algorithms in order to produce artificial intelligence models. The desired models tend to become more complex and/or trained in a more complex and thorough manner, which leads to an increase in the quality and quantity of the data required. Crowdsourcing is an effective way to get input from humans in order to label large datasets. The human labelers from the crowd may mark-up or annotate the data to show a target that artificial intelligence model will is expected to predict. Therefore, the data used to train artificial intelligence models needs to be structured and labeled correctly. Several techniques are used to measure the quality of the labeling such as comparing the suggested labels with labels from a gold standard that are considered correct. Another technique is sample review in which a random sample of the labeled data is selected to be reviewed by a more experienced worker. Yet another well known technique is based on consensus which means that several labelers are assigned to perform the same labeling task and the correct label is the label returned by the majority of labelers.

As the datasets grow larger and larger, improving the production of labels is expected to bring advantages in terms of cost of the labelling process, quality of the resulting labelled datasets, and required time to produce the labelled datasets. The present invention addresses such needs.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for improving quality of a dataset for which a labeling task is to be completed. The method repeats a loop comprising: inferring, for each of the labeler identifiers in the dataset, an estimated proficiency value; inferring a predicted uncertainty value of correctness of the label for at least a subset of the raw data items; and receiving a trusted evaluation value of correctness for one or more labels of the subset of the raw data items for which the predicted uncertainty is inferred. The method repeats the loop until the highest predicted uncertainty value in the dataset is below a threshold value. Other embodiments of this aspect include corresponding computer systems, apparatus, and computer programs recorded on one or more computer storage devices, each configured to perform the actions of the methods.

Implementations may include one or more of the following features. The method may include inferring, for the labeling task to be completed, an estimated difficulty value. The method may include replacing a portion of the subset of labels having associated therewith the highest predicted uncertainty values with random labels of the dataset prior to requiring the trusted evaluation. The method may include requiring a trusted evaluation for each label of a subset of labels having associated therewith the highest predicted uncertainty values. The method may include inserting into the dataset the trusted evaluation of each label for which the trusted evaluation is received. The method may include complete computing until financial resources or time resources are exhausted. The method may include communicating a subset of labels associated to a subset of data items to trusted evaluators. The method may include quantifying proficiency of a labeler by computing correctness evaluation from experts compared to an initial submission from the labeler. Crowd-sourced vetting may be combined with trusted vetting to improve the quality of the dataset. Implementations of the described techniques may include hardware, a method or process, or computer software on a computer-accessible medium.

One general aspect includes a labeling system configured for improving quality of a dataset. The labeling system also includes a memory module for storing a running list of items being labeled; a processor module configured to repeat a loop: infer, for each of the labeler identifiers in the dataset, an estimated proficiency value; infer a distribution for the degree of randomness in the correctness of the labels; infer at least one predicted uncertainty value of correctness of the label for at least a subset of the raw data items; and receive a trusted evaluation value of correctness for one or more labels of the subset of the raw data items for which the predicted uncertainty is inferred. The system repeats the loop until the highest uncertainty is below a threshold value. Other embodiments of this aspect include corresponding computer systems, apparatus, and computer programs recorded on one or more computer storage devices, each configured to perform the actions of the methods.

Implementations may include one or more of the following features. The processor module may further be for inferring, for the labeling task to be completed, an estimated difficulty value. The processor module may further be for replacing a portion of the subset of labels having associated therewith the highest predicted uncertainty values with random labels of the dataset prior to requiring a trusted evaluation. The processor module may further be for selectively requiring a trusted evaluation for each label of a subset of labels having associated therewith the highest predicted uncertainty values. The processor module may further be for inserting into the dataset the trusted evaluation of each label for which the trusted evaluation is received. The labeling system may include a network interface module for interfacing with a plurality of remote trusted evaluators. The labeling system may include a network interface module for communicating a subset of labels associated to a subset of data items to trusted evaluators. The labeling system may include a network interface module for communicating trusted evaluation of labels associated to raw data items to the processor module. The processor module may further complete computing until financial resources or time resources are exhausted. The processor module may further be for quantifying proficiency of a labeler by computing correctness evaluation from experts compared to an initial submission from the labeler. The processor module may further be for combining crowd-sourced vetting with trusted vetting to improve the quality of the dataset. Implementations of the described techniques may include hardware, a method or process, or computer software on a computer-accessible medium.

### BRIEF DESCRIPTION OF THE DRAWINGS

Further features and exemplary advantages of the present invention will become apparent from the following detailed description, taken in conjunction with the appended drawings, in which:

FIG. 1A shows a data item of a dataset in accordance with the teachings of the present invention;

FIG. 1B shows a label representing an answer to an annotation request associated with the data item of FIG. 1A in accordance with the teachings of the present invention;

FIG. 2 is a flow chart of an exemplary method for improving the quality of a dataset in accordance with the teachings of a first set of embodiments of the present invention;

FIG. 3 is a flow chart of an exemplary method for improving the quality of a dataset in accordance with the teachings of a second set of embodiments of the present invention; and

FIG. 4 is a logical modular representation of an exemplary labeling system in accordance with the teachings of the present invention.

### DETAILED DESCRIPTION

Crowdsourcing is an effective way to mobilize human cognitive abilities to handle computer-hard tasks such as transcription, sentiment analysis and image recognition. In general, the resulting crowd-sourced datasets are used to train artificial intelligence and therefore, needs to be large, of high quality and fast to produce. Consequently, during the process of producing labelled datasets the three components that are expected to be optimized are the cost of the labelling process, the quality of the resulting labelled datasets, and the required time to produce the labelled datasets. In general, a trade-off between cost, quality, and time has to be made as producing high quality labelled datasets can get highly expensive and time consuming. Beside, one can decide to rapidly produce high quality labelled datasets but then the production costs will, in all likelihood, be high as well. The present invention provides an improved alternative to optimize the cost, quality, and time during the production of labelled datasets by asking experts to vet some portions of the crowd-sourced labels in the datasets. Expert vetting is often slow and challenging mainly because experts are rare. Additionally, expert vetting is time and financial resources consuming. The rarity of experts creates limitations in their availability which makes it even more challenging to expertly vet large sets of data.

Embodiments of the present invention provides a method and a system for combining trusted vetting with crowd-sourced labeling. One goal is to produce a dataset of higher quality that may be used, for instance, for training artificial intelligence algorithms. In some embodiments, an expert has to vet only a selected portion of the crowd-sourced labels while improving overall quality of a dataset. In this exemplary embodiment, a strategy may be developed to reduce the size of the portion of the dataset that is expertly vetted.

In accordance with a first set of embodiments, a method and a system are provided for improving quality of a dataset while minimizing resource consumption associated to production of the dataset. The dataset contains raw data items for which a labeling task is to be completed (e.g., a sentence for which a translation is to be completed). Each labelling task may regroup one or more annotation requests. Therefore, each data item may have associated therewith one or more annotation requests. The dataset also comprises for each data item, for each annotation request one or more labels representing answers to the annotation request. The dataset also comprises a unique labeler identifier for each labeler.

A labeler is the entity producing the labels of one or more data items (e.g., a person that provides a translation). The labeler can be a person or group of persons or a system or group of systems. As explained above, for each labeler, a corresponding labeler identifier is included in the dataset. A unique labeler identifier does not only provide the exemplary advantages of facilitating data treatment, retrieving, and storing but also help in reducing potential bias in the expert's vetting.

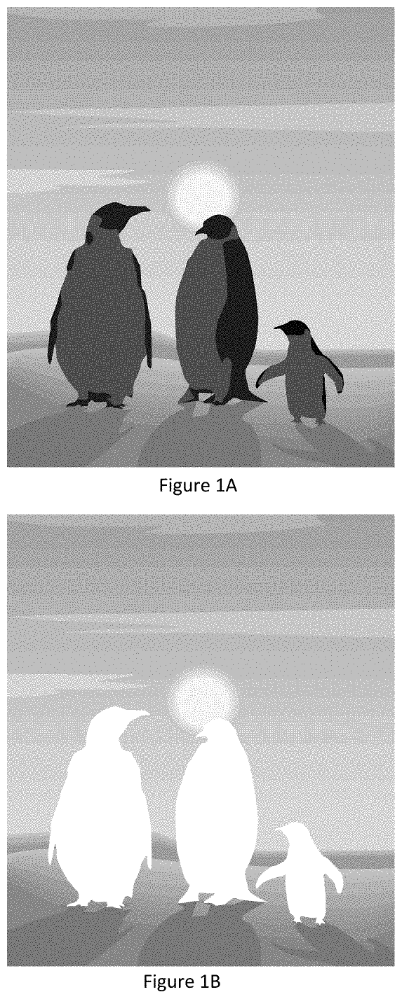

FIG. 1A shows a hypothetical data item for which a classification task is to be performed. The classification task may, for example, include a plurality of annotation requests such as: Is there an animal in the image of the data item? Identify the name of the species in the image of the data item? Segment the image of the data item to bring-out or highlight the animal. For each annotation request, a labeler will produce a label answering the annotation request. In case of the data item of FIG. 1A, the labeler may answer the first annotation request with a “yes”, the second with “lesser auk”, and the third with the image of FIG. 1B.

In a preferred set of embodiments, the labeler may be asked to produce answers for a first annotation request for a plurality of data items of the dataset, and then to produce answers for a second annotation request for a plurality of data items of the dataset, and so on.

A labelling task is associated to a data item and might comprise one or more annotation requests, or sub tasks, as exemplified with reference to FIGS. 1A and 1B. For the sake of simplicity, in the present discussion, the terminology “labelling task” will be used to represent a single annotation request. Skilled persons will readily acknowledge that the labelling task may however represent more than one annotation request and that the teachings related to the present invention should be construed as such.

During the labeling task, a labeler is asked to produce one or more labels for a selection of data items that need to be labeled. A plurality of labelers may produce different correct labels to answer one task. This is due to the fact that the correct label is not necessarily unique and a data item may admit several labels. Additionally, the difficulty of the each labeling task may be different and is not a directly observable quantity. An example of a typical labeling task would be translating or paraphrasing a phrase or a paragraph. In general, there are many potential correct translations or paraphrases. In this example, the difficulty can occur because of the language structure, cultural references, polysemy, etc. Thus, the difficulty of the labeling task cannot be easily measured but is manifested implicitly in the labeling task's ensuing labels.

Each labeler may have a different proficiency that is not a directly observable and/or measurable quantity. The labeler proficiency may vary depending on the task to be performed as a labeler may have an affinity with certain types of tasks. In the previous example, the labeler proficiency may vary depending on the labeler's experience, the difficulty of the translation or paraphrasing task, the competence of the labeler in the specific field of the phrase or paragraph it relates to, etc. The labeler proficiency may be inferred for each labeler.

The label provided by the labeler may not represent a correct label or the best label to the labeling task. In the context of the present invention, trusted evaluators are made available for vetting a subset of the labels. The trusted evaluator is considered as an infallible source for judging and deciding on the correctness of labels. For instance, the trusted evaluator is able to provide a trusted evaluation value of correctness of labels. For the purpose of the example, the trusted evaluator's trusted evaluation value is not to be doubted. Said differently, the trusted evaluation value is explicitly considered correct. The trusted evaluator may be a human expert or group of experts, or an expert system or group of expert systems (e.g., AI-based). In the previous example, the trusted evaluator may be a translation expert.

The trusted evaluation value of correctness may be added to the dataset once it is provided by the trusted evaluators.

The trusted evaluation value of correctness of labels provided by the trusted evaluator can be represented by several data types. Primitive data types such as Boolean and numeric values are examples of data types of the trusted evaluation value. The trusted evaluation value can also be represented by non-primitive data types such as symbols.

The difficulty of the labeling task and the labeler proficiency may explain, at least partially, the correctness of the labels of the labeling task thereat. Besides, randomness may be partially responsible for the correctness of the labeling task's ensuing labels.

Generally, one could explain the context of the described embodiments as combining expert vetting with crowd-sourced labeling for producing a high quality dataset taking into account the proficiency of the labeler and the difficulty of the labeling task.

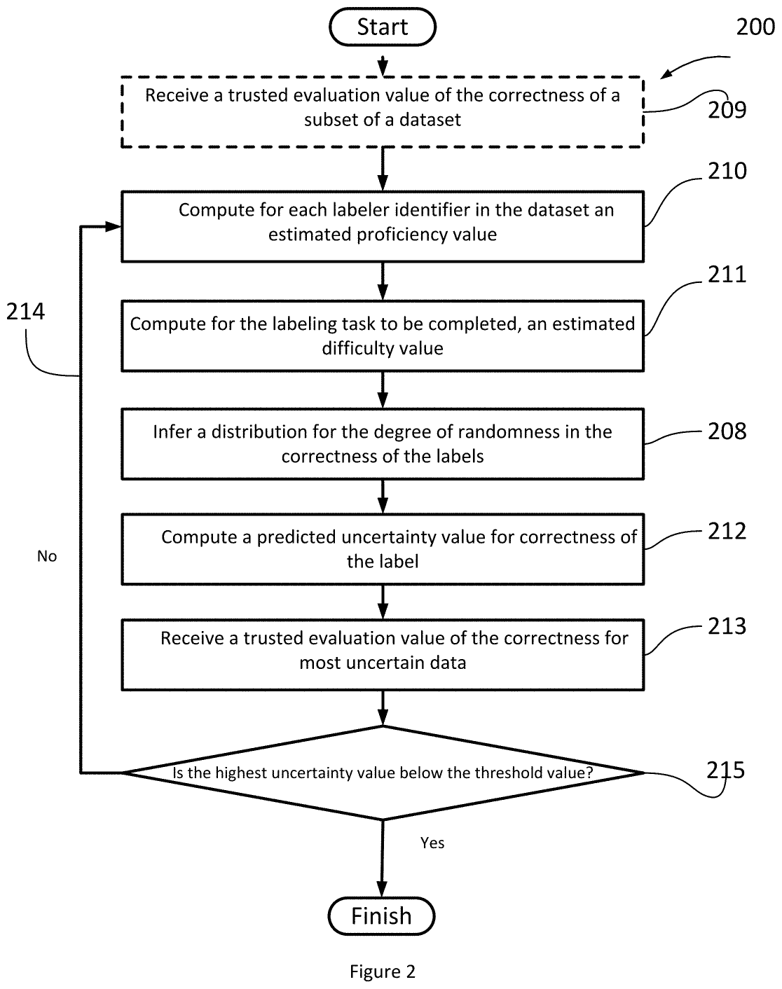

Reference is now made to the drawings in which FIG. 2 shows a flow chart of an exemplary method 200 for improving the quality of a dataset. The method 200 may optionally begin with receiving 209 a trusted evaluation value of correctness of labels associated with a subset of the dataset. The method 200 may alternatively begin with inferring 210 an estimated proficiency value for each of the labeler identifiers present in the dataset. The method 200 also comprises inferring 211 an estimated difficulty value for each labelling task of the dataset. A distribution for the degree of randomness in the correctness of the labels is also inferred 208. The method 200 also comprises inferring 212 a predicted uncertainty value of correctness of the label. From the inferred 212 value for correctness of the label, a group of the data items having associated therewith the highest predicted uncertainty values may be obtained (e.g., 30 worst predicted uncertainty value). A trusted evaluation value of correctness of one or more of the group of the data items is thereafter obtained 213 from trusted evaluator(s). As can be appreciated, once the trusted evaluator provides the trusted evaluation value of the correctness, the predicted uncertainty value is thereafter not considered in listing the worst predicted uncertainty values until the label is modified. For instance, the trusted evaluator may have rejected the label and a new label should afterwards be provided. The new label may then be vetted, leading to a new trusted evaluation value of the correctness. The steps of the method 200 are then repeated 214 until the highest predicted uncertainty value in the dataset is below a threshold value.

A person skilled in the art will already recognize that a plurality of steps of the method 200 (e.g., 208, 211, 210, etc.) may be performed in different order without affecting the teachings of the present invention.

In the case of the present invention, inference of a value of interest from a dataset amounts to deducing an estimated value that approximates the value of interest using a probabilistic data analysis of the dataset.

TABLE 1
dataset example

| Task | Labeler | Data | | Expert | Predicted |
|---|---|---|---|---|---|
| ID | ID | item | Label | evaluation | uncertainty |
| 1 | 1 | bleu | blue | 1 | |
| 1 | 2 | bleu | blue | 1 | |
| 2 | 1 | noir | black | 1 | |
| 2 | 2 | noir | black | 1 | |
| 3 | 1 | jaune | yellow | 1 | |
| 4 | 2 | femme | woman | 1 | |
| 4 | 1 | femme | woman | 1 | |
| 1 | 2 | bleu | blues | 0 | |
| 5 | 3 | rouge | wine | 0 | |
| 6 | 2 | enfant | child | 1 | |
| 7 | 3 | gris | dark | 0 | |
| 8 | 2 | parc | garden | 0 | |
| 9 | 3 | arbre | tree | 1 | |
| 10 | 3 | soleil | sun | 1 | |
| 11 | 3 | plante | plant | 1 | |
| 12 | 1 | homme | men | 0 | |
| 13 | 1 | enfants | child | | 1/2 |
| 5 | 2 | rouge | red | | 1/3 |
| 14 | 3 | bleus | blue | | 2/2 |
| 15 | 3 | femmes | women | | 1 |

In the previous example, the labeling task may relate to a translation of a text where the trusted evaluator is a translation expert, the labelers are translators (each having a translator identifier) and the labels are translations of the text. In this example, the labelling task is not composed with a plurality of annotation requests. Table 1 presents an exemplary dataset to be discussed with regards to method 200 of FIG. 2. Skilled persons will readily recognize that the exemplary dataset of Table 1 is simplified for the purpose of illustrating the teachings of the present invention. For the sake of example, the text to be translated is divided into three major categories: nature, color, and human-related texts.

The method 200 begins once the translators have translated the text in the dataset (i.e., when the labelers have provided the label). The method 200 may begin with receiving 209 a trusted evaluation value of correctness of translations of a subset of the data items (e.g., text). In the example of Table 1, the received trusted evaluation value of correctness of translations is provided by the translation expert. A distribution for the degree of randomness in the correctness of the labels is inferred 208 based on the trusted evaluation value of correctness of labels using a Bayesian machine learning model. The following discussion is meant to illustrate how this is achieved.

The labeler w from the labeler crowd W fulfils labelling task T_i by providing their j-th solution y_{iwj} to the task instance x_i. For instance, y_{iwj} is the j-th French translation provided by the labeler w of the English sentence x_i as it appears in the i-th translation task T_i. Optionally, the vetting provider w′ from the vetting provider crowd W′ fulfils labelling task T_{iwj}′ by providing a true/false decision y_{iwjw}′ for whether or not the given label y_{iwj} is a correct solution to the task instance x_i of task T_i. The *observed* data that serves as an input for the model comprises:
a sequence of trusted correctness labels c_{iwj};
the trusted correctness label c_{iwj} is a true/false decision by an expert for whether or not the given label y_{iwj} is a correct solution to the task instance x_i of task T_i by the labeler w;
optionally a sequence of provided (untrusted) correctness labels y_{iwjw}′;
the provided correctness label y_{iwjw′}′ is a true/false decision made by the vetting provider w′ for whether or not the given label y_{iwj} is a correct solution to the task instance x_i of task T_i by labeler w;
for all provided correctness labels y_{iwjw}′, is defined c_{iwjw}′=XNOR(y_{iwjw}′, c_{iwj}) as the trusted correctness of the provided correctness label, where XNOR is the exclusive NOR operation. The result of the XNOR operation is True if and only if y_{iwjw′}′ and c_{iwj} agree (that is, are either both true or both false).

The task of the AI model is to predict the expectation value E {iwj} and the uncertainty H_{iwj} of the *unobserved* trusted true/false decisions c_{iwj} for whether or not the given label y_{iwj} is a correct solution to the task instance x_i of task T_i. The AI model acts as a classification model, a clustering model, or a mix of both, depending on which trusted correctness labels c_{iwj} are observed and which are not.

When the uncertainty $H_{iwj}$ satisfies the active learning criterion (e.g., is among the top-k highest uncertainties), a trusted expert fulfils the labelling task G_{iwj}′ by providing the ground-truth true/false decision c_{iwj} for whether or not the given label y_{iwj} is a correct solution to the task instance x_i of task T_i. The new trusted decisions c_{iwj} are admitted to the set of *observed* data and the prediction calculations are repeated.

As an example, here is provided a simple implementation of the A model based on Item Response Theory.

Let the latent parameters of an AI model L be:
alpha_w; the labelling proficiency of the labeler w of W,
mu_alpha; the average labelling proficiency of all labelers in W,
beta_i; the labelling difficulty of the labelling task T_i,
alpha_{w}′; the vetting proficiency of the vetting provider w′ of W′,
mu_alpha′; the average vetting proficiency of all vetting providers in W′, and
beta_{iwj}′; the vetting difficulty of the vetting task T_{iwj}′.

In a simple Bayesian invocation of the L model, the trusted true/false decisions c_{iwj} can be generated according to a Bernoulli distribution,

c_{iwj}alpha_w,mu alpha,beta_i˜Bernoulli(logit\hat{ }{−1}(alpha_w+mu_alpha−beta_i)).

Similarly, the trusted correctnesses c_{iwjw}′ of the provided correctness decisions y_{iwjw′}′ can also be generated according to a Bernoulli distribution,

c_{iwjw′}′ alpha_{w′}′,mu_alpha′,beta_{iwj}′ Bernoulli(logit\hat{ }{−1}(alpha_{w′}′+mu_alpha′−beta_{iwj}′)).

Furthermore, alpha_w, mu_alpha, beta_i, alpha_{w}′, mu_alpha′, and beta_{iwj}′ can be generated according to suitable prior distributions that can have additional latent parameters.

Full Bayesian posterior predictive inference for the L model can be implemented by modelling the joint generation of both labeled and unlabeled data. Standard Bayesian inference algorithms (e.g., Markov Chain Monte-Carlo) can be used to estimate both, the posterior distribution of the latent model parameters (alpha_w, mu_alpha, beta_i, alpha_{w′}′, mu_alpha′, and beta_{iwj}′) and the posterior distribution over the unobserved true/false decisions c_{iwj}. Thus, both the observed and the unobserved data contribute to the estimation of the unobserved decisions c_{iwj}.

For the sake of example, consider that labels provided by labelers are not random. An estimated proficiency value is inferred 210 for each translator identifier present in the dataset. Based on the expert's evaluation of Table 1, one can note that the labelers associated with the labeler identifiers 1, 3, and 2 are proficient in translating color, nature, and human-related texts, respectively. One may also note that the proficiency of the labelers associated with the labeler identifiers 1 and 3 regarding nature and human related-texts, respectively, is not yet known. Indeed, the labelers did not yet produce any related translation. The method 200 infers 211 an estimated difficulty value for each phrase of the dataset. In order to simplify the present example, the estimated difficulty value is set, hypothetically, to the same value for every data item. The method 200 also infers 212 a predicted uncertainty value of correctness of the translation. At the first iteration, the labeler identifier 1 provided two human-related translations of which only one was found to be true. The predicted uncertainty associated with labeling task ID 13, which is a human-related text to be translated by labeler identifier 1, is then 1/2. Similarly, at the first iteration, the labeler identifier 2 provided three color-related translations of which two were found to be true. The predicted uncertainty associated with labeling task ID 5, which is a color-related text to be translated by labeler identifier 2, is then 1/3. The labeler identifier 3 did not translate a human-related text at the first iteration and is asked to produce a human-related text translation for the task ID 15. The method 200, may decide to associate a predicted uncertainty value of correctness of the label of 1 to the task ID 15 (e.g., to increase the chances for the labeling task ID15 to be expertly vetted). The group of paragraph having associated therewith the highest predicted uncertainty values may be obtained (e.g., 10 worst predicted uncertainty value). A trusted evaluation value of correctness of one or more of these paragraphs is obtained 213. The method 200 is then repeated 214 until the highest predicted uncertainty value in the dataset is below a threshold value. In this example, each task ID is associated to a data item and vice versa. Consequently, it is implied that the method 200 infers an uncertainty value for each label of each labeler.

In the previous example, only one task was to be performed and the data items have been grouped into three groups (i.e., nature, human, and color). For each labeler, for each data item of a given group, a predicted uncertainty have been computed. The efficiency of labeler ID 3 may be considered to be 3/5 as he produced five labels and three of whom were correct.

A person skilled in the art will already recognize that the estimated proficiency value, the estimated difficulty value and the predicted uncertainty value of correctness represent probability distributions for the labeler proficiency, the labeling task difficulty, and the uncertainty of correctness of the label.

In addition or alternatively, the embodiment may also allow for a fraction of the labels with the highest predicted uncertainty values to be replaced with a random set of labels of the dataset before being vetted by the trusted evaluators. The random set of labels may contain labels previously vetted or non-vetted by the trusted evaluators.

The threshold value on highest predicted uncertainty value can be a preset value (e.g., 0.15 representing a probability between 0 and 1). It can also refer to an average predicted uncertainty value or a variation of the average predicted uncertainty value between different iterations of the repeated steps of the method 200. A person skilled in the art will recognize that the ways of setting the threshold value do not affect the teachings of the present invention.

The method 200 can, alternatively or in addition, admit different exit conditions. Examples of exit conditions include conditions related to resource consumption associated to the production of the dataset. The resources may be financial resources, time resources or of any other type. In the case of human experts providing the trusted evaluation values, the cost associated with each labeling task is an example of a financial resource. The cost can be direct such as the hourly fee of the expert or indirect such as the energy cost of the production of a dataset. The time required to a human expert to vet a subset of the dataset is an example of a time resource that is directly related to the production of the dataset. In the case where the expert is an expert system, a typical example of financial resources can be the indirect costs of acquisition and maintenance of the system.

The method 200 can be used in cases where the labeling task varies for different data items. For example, a translation can be required for a first subset of the dataset and a paraphrasing task can be required for a second subset of the dataset. The method 200 can also be used in cases where a plurality of labeling tasks are required for each data item. An example would be translating and paraphrasing a first subset of the dataset, translating a second subset and paraphrasing a third subset.

A person skilled in the art will already recognize that there are many labeling tasks that can be supported by the present invention. Examples of labeling tasks include: translating a text, answering a question, grading or giving a qualitative evaluation, transcription, content moderation, data categorization and/or classification, search relevance where the labeler is asked to return relevant results on the first search, etc. Optical character recognition is an example of a transcription task where the labeler is given an image containing some form of text and is asked to replicate the text contained in the image in form of a sequence of characters. An example of classification task is a task where the labeler is asked to specify the class to which a data point belongs.

In another embodiment, vetting providers are introduced to perform an evaluation of the correctness of the labels provided by the labelers. The vetting providers are labelers performing the same task as the trusted evaluators. The vetting providers are introduced to overcome limitations created by the unavailability of experts, as vetting providers are amply available. In such an example, one could explain the context as combining expert vetting with crowd-sourced vetting and crowd-sourced labeling for improving quality of a dataset. The dataset contains raw data items for which a labeling task is to be completed (e.g., a sentence for which a translation is to be completed). Each labelling task may regroup one or more annotation requests. Therefore, each data item may have associated therewith one or more annotation requests. The dataset also comprises for each data item and each annotation request one or more labels representing answers to the annotation request. The dataset also comprises a unique labeler identifier for each labeler.

A labeler is the entity producing the labels of one or more data items (e.g., a person that provides a translation). The labeler can be a person or group of persons or a system or group of systems. As explained above, for each labeler, a corresponding labeler identifier is included in the dataset. A labeler identifier may not only provide the exemplary advantages of facilitating data treatment, retrieving, and storing but also help in reducing potential bias in the expert's vetting. The dataset also comprises vetting provider identifier, also referred to as provider identifier, permitting to retrieve the entity making the vetting associated with a label.

The label provided by the labeler may not represent a correct label or the best label to the labeling task. In the context of the present invention, trusted evaluators are made available for vetting a subset of the labels. The trusted evaluator is considered as an infallible source for judging and deciding on the correctness of labels. For instance, the trusted evaluator is able to provide a trusted evaluation value of correctness of labels. For the purpose of the example, the trusted evaluator's trusted evaluation value is not to be doubted. Said differently, the trusted evaluation value is explicitly considered correct. The trusted evaluator may be a human expert or group of experts, or an expert system or group of expert systems (e.g., AI-based).

In the previous example, the trusted evaluator may be a translation expert. In addition to the trusted evaluators, the vetting crowd produces vetted evaluation value of correctness of the labels provided by the labelers. The vetted evaluation values of correctness are not as trusted as the trusted evaluation as the vetted evaluation values of correctness may not represent a correct vetting or the best vetting to the labeling task. In the context of the present invention, the vetted evaluation values of correctness are considered to be fallible evaluation of correctness of labels. Said differently, the vetted evaluation values of correctness may be incorrect. Contrarily to the trusted evaluators, the crowd-sourced vettings may be biased. The vetting provider may be a human or group of humans, or a system or group of systems. In the example of a translation task, the vetting provider may be a translator or a group of translators.

The vetted evaluation value of correctness and the trusted evaluation value of correctness may be added to the dataset once they are provided by the vetting providers and the trusted evaluators.

The vetting providers may comprise labelers with lower estimated proficiency value from the labeling crowd. The benefit of using labelers with lower estimated proficiency value is to minimize initial uncertainty value for correctness of the labels by preventing unqualified labelers from labeling the data items. Another way of forming the vetting providers may be by getting labelers to vet labels produced by their labeling group. In this case, a statistical association between initial labeling tasks and the vetting tasks can affect the quality of the vetting process. The correlation between the initial labeling tasks and the vetting tasks is taken into account in the present invention. A person skilled in the art will already recognize that the different ways of forming the vetting providers do not affect the teachings of the present invention.

During vetting, a vetting provider is asked to produce a vetted evaluation value of correctness for each label that needs to be vetted. The difficulty of vetting is potentially different for each label and is not a directly observable quantity. An example of a typical vetting would be evaluating a translation of a phrase or a paragraph previously translated. A person skilled in the art will already recognize that there are many potential correct translations and depending on the phrase or the paragraph, the difficulty of vetting a translation can be different. In this example, the difficulty can occur because of the language structure, cultural references, polysemy, etc. Thus, the difficulty of vetting cannot be easily measured but is manifested implicitly in the agreement of the vetted evaluation value of correctness with the trusted evaluation value of correctness.

The provider identifier proficiency may vary depending on the data item on which the labeling task is to be performed and on the label produced by the labeler. Thus, the provider identifier proficiency is not necessarily a directly observable quantity but it is manifested implicitly in the agreement of the vetted evaluation value of correctness with the trusted evaluation value of correctness. In the example of a paragraph translation task, the provider identifier proficiency may vary depending on the provider identifier's experience, the difficulty of the translation task, the competence of the vetting provider in the specific field of the paragraph it relates to, etc. The vetting proficiency may be inferred for each vetting provider.

Another source of variation in the provider identifier proficiency is the proficiency of the labeler. For example, if the first labeler produces a label of high quality, a vetting provider may be overwhelmed or outmatched and may produce a wrong or a random vet.

The trusted evaluation value of correctness of labels and the vetted evaluation value of correctness can be represented by several data types. Primitive data types such as Boolean and numeric values are examples of the data type of the trusted evaluation value and the vetted evaluation value of correctness. The trusted evaluation value and the vetted evaluation value of correctness can also be represented by non-primitive data types such as symbols.

The difficulty of the labeling task and vetting for each of the data items, the labeler proficiency and the vetting provider proficiency may explain, at least partially, the correctness of the vetting results. Besides, randomness may be partially responsible for the correctness of the vetting results.

In a preferred set of embodiments, the vetting providers primarily vet the most uncertain labels.

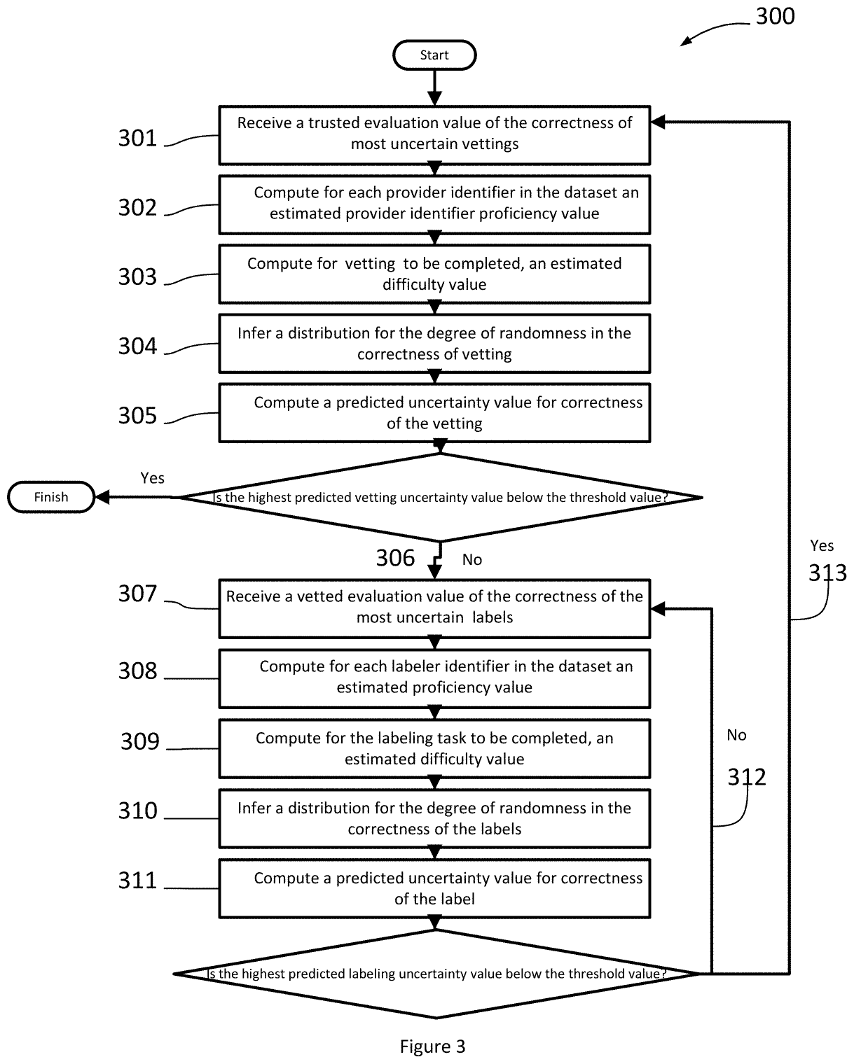

Reference is now made to the drawings in which FIG. 3 shows a flow chart of an exemplary method 300 for improving the quality of a dataset by combining expert vetting with crowd-sourced vetting and crowd-sourced labeling. At the first iteration of the method, the group of data considered as most uncertain data may be a random group of the dataset. A trusted evaluation value of correctness of the group of the data items is thereafter obtained 301 from the trusted evaluator(s). For each provider identifier in the dataset an estimated provider identifier proficiency value in inferred 302. The method comprises inferring 303 for the vetting to be completed, an estimated difficulty value. The method also comprises inferring 304 a distribution for the degree of randomness in the correctness of the vettings. A predicted uncertainty value of correctness of the vetting is also inferred 305. From the inferred 305 value of correctness of a vetting, a group of the data items having associated therewith the highest predicted vetting uncertainty values may be obtained (e.g., 25 worst predicted uncertainty value). Once the highest vetting uncertainty value for correctness is below a threshold value, the method is terminated. Otherwise 306, a vetted evaluation value of the correctness of the most uncertain labels is received 307. Similarly, at the first iteration of the method steps, the group of data considered as most uncertain data may be a random group of the dataset. For each labeler identifier in the dataset an estimated proficiency value in inferred 308. The method comprises inferring 309 for the completed labeling, an estimated difficulty value. The method also comprises inferring 310 a distribution for the degree of randomness in the correctness of the labels. The method also comprises inferring 311 a predicted uncertainty value of correctness of the label. From the inferred uncertainty value of correctness of a label, a group of the data items having associated therewith the highest predicted labeling uncertainty values may be obtained (e.g., 35 worst predicted uncertainty value). The steps 307-311 are repeated 312 until the highest labeling uncertainty value for correctness is below a threshold value. A new trusted evaluation value of correctness of the most uncertain vettings is received 301 once the highest labeling uncertainty value for correctness is below a threshold value.

A person skilled in the art will already recognize that a plurality of steps of the method 300 (e.g., 302, 303, 304, etc.) may be performed in different order without affecting the teachings of the present invention.

In cases where vetting providers are formed by getting labelers to vet labels produced by their labeling group. The correlation between the initial labeling tasks and the vetting tasks is taken into account during step 304 of the method 300 where a distribution for the degree of randomness in the correctness of the vettings is inferred.

The distribution for the degree of randomness in the correctness of the labels is inferred based on the vetted evaluation value of correctness of labels using a Bayesian machine learning model. Likewise, a distribution for the degree of randomness in the correctness of the vetting results is inferred based on the trusted evaluation value of correctness of vettings using a Bayesian machine learning model. A person skilled in the art will already recognize that the estimated proficiency values and the estimated difficulty values represent probability distributions.

In addition or alternatively, the embodiment may also allow for a fraction of the labels with the highest predicted uncertainty values to be replaced with a random set of labels of the dataset before being vetted by the vetting providers. The random set of labels may contain labels previously vetted or non-vetted by the vetting providers. Likewise, a fraction of the vettings with the highest predicted uncertainty values is replaced with a random set of vettings of the dataset before being vetted by the trusted evaluators. The random set may contain vettings previously vetted or non-vetted by the trusted evaluators.

The threshold value on highest predicted uncertainty value can refer to a preset value (e.g., 0.15). It can also refer to an average uncertainty value or a variation of the average uncertainty value between different iterations of the repeated steps of the method 300. A person skilled in the art will recognize that the ways of setting the threshold value do not affect the teachings of the present invention.

The method 300 can, in addition or alternatively, admit different exit conditions. Examples of exit conditions include conditions related to resource consumption associated to the production of the dataset. The resources may be financial resources, time resources or other types of resources. In the case of human experts providing the trusted evaluation values, the cost associated with each labeling task is an example of a financial resource. The cost can be direct such as the hourly fee of the expert or indirect such as the energy cost of the production of a dataset. The time required to a human expert to vet a subset of the dataset is an example of a time resource that is directly related to the production of the dataset. In the case where the expert is an expert system, a typical example of financial resources can be the indirect costs of acquisition and maintenance of the system.

The method 300 can be used in cases where the labeling task vary for different data items. For example, a translation can be required for a first subset of the dataset and a paraphrasing task can be required for a second subset of the dataset. The method 300 can also be used in cases where a plurality of labeling tasks are required for each data item. An example would be translating and paraphrasing a first subset of the dataset, translating a second subset and paraphrasing a third subset.

A person skilled in the art will already recognize that there are many labeling tasks that can be performed by the present invention. Examples of labeling tasks include: translating a text, answering a question, providing a solution to a problem, grading or giving a qualitative evaluation, transcription, content moderation, data categorization, search relevance where the labeler is asked to return relevant results on the first search etc.

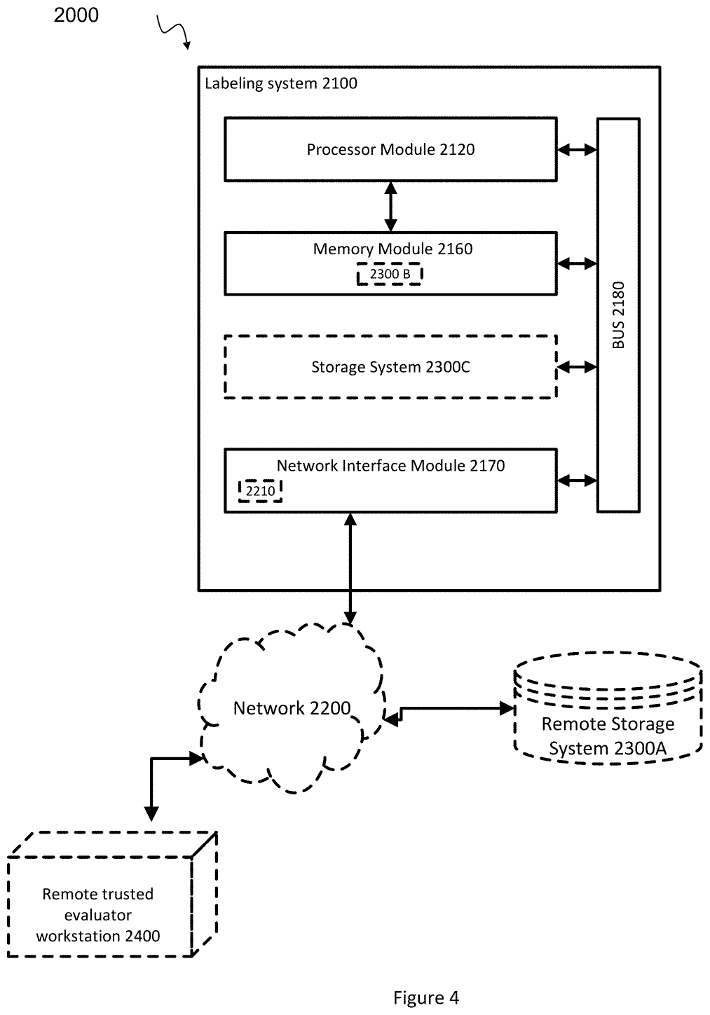

FIG. 4 shows a logical modular representation of an exemplary system 2000 comprising a labeling system 2100 for labeling a dataset. The labeling system 2100 comprises a memory module 2160, a processor module 2120, and a network interface module 2170. The exemplified system 2000 may also comprise a remote trusted evaluator workstation 2400, which may, in certain embodiments, be implemented as a thin client to the application running on the labeling system 2100. The system 2000 may also include a storage system 2300. The system 2000 includes a network 2200 that connects the remote trusted evaluator workstation 2400 to the labeling system 2100 and may also be used for accessing storage system 2300 or other nodes (not shown). The network 2200 comprises one or more network channels 2210 between the labeling system 2100 and the workstation 2400.

The labeling system 2100 may comprise a storage system 2300 for storing and accessing long-term or non-transitory data and may further log data while the labeling system is being used. FIG. 4 shows examples of the storage system 2300 as a distinct database system 2300A, a distinct module 2300C of the labeling system 2100 or a sub-module 2300B of the memory module 2160 of the labeling system 2100. The storage system 2300 may be distributed over different systems A, B, C. The storage system 2300 may comprise one or more logical or physical as well as local or remote hard disk drive (HDD) (or an array thereof). The storage system 2300 may further comprise a local or remote database made accessible to the labeling system 2100 by a standardized or proprietary interface or via the network interface module 2170. The variants of storage system 2300 usable in the context of the present invention will be readily apparent to persons skilled in the art.

In the depicted example of FIG. 4, the labeling system 2100 shows an optional remote storage system 2300A which may communicate through the network 2200 with the labeling system 2100. The storage module 2300, (e.g., a networked data storage system) accessible to all modules of the labeling system 2100 via the network interface module 2170 through a network 2200, may be used to store data. The storage system 2300 may represent one or more logical or physical as well as local or remote hard disk drive (HDD) (or an array thereof). The storage system 2300 may further represent a local 2300B, 2300C or remote database 2300A made accessible to the network node 2200 by a standardized or proprietary interface. The network interface module 2170 represents at least one physical interface that can be used to communicate with other network nodes. The network interface module 2170 may be made visible to the other modules of the network node 2200 through one or more logical interfaces. The actual stacks of protocols used by the physical network interface(s) and/or logical network interface(s) of the network interface module 2170 do not affect the teachings of the present invention. The variants of processor module 2120, memory module 2160, network interface module 2170 and storage system 2300 usable in the context of the present invention will be readily apparent to persons skilled in the art.

Likewise, even though explicit mentions of the memory module 2160 and/or the processor module 2120 are not made throughout the description of the present examples, persons skilled in the art will readily recognize that such modules are used in conjunction with other modules of the network node 2170 to perform routine as well as innovative steps related to the present invention.

The processor module 2120 may represent a single processor with one or more processor cores or an array of processors, each comprising one or more processor cores. The memory module 2160 may comprise various types of memory (different standardized or kinds of Random Access Memory (RAM) modules, memory cards, Read-Only Memory (ROM) modules, programmable ROM, etc.). The network interface module 2170 represents at least one physical interface that can be used to communicate with other network nodes. The network interface module 2170 may be made visible to the other modules of the labeling system 2100 through one or more logical interfaces. The actual stacks of protocols used by the physical network interface(s) and/or logical network interface(s) 2210 of the network interface module 2170 do not affect the teachings of the present invention. The variants of processor module 2120, memory module 2160 and network interface module 2170 usable in the context of the present invention will be readily apparent to persons skilled in the art.

A bus 2180 is depicted as an example of means for exchanging data between the different modules of the labeling system 2100. The present invention is not affected by the way the different modules exchange information. For instance, the memory module 2160 and the processor module 2120 could be connected by a parallel bus, but could also be connected by a serial connection or involve an intermediate module (not shown) without affecting the teachings of the present invention.

The labeling system 2100 allows a labeler or group of labelers to perform a labeling task on a dataset stored in the local 2300B, 2300C or remote storage system 2300A. In the case of a dataset stored in a remote data storage 2300A, the network interface module 2170 provides the labeler and the vetting provider with access to the dataset through a network 2200. The ensuing labels and vettings may be added to the dataset and may be stored in a memory module 2160 as they are produced. A trusted evaluation value of correctness of the label and a vetted evaluation value of the correctness of the vetting are received (e.g., 213 and 309) for fractions of the dataset. The trusted evaluation is provided by trusted evaluators located in trusted evaluator's workstation that can be remote trusted evaluator workstation 2400 from the labeling system 2100 or at the same location (not shown). Likewise, the vetted evaluation is provided by vetting provider identifiers located in a vetting provider's workstation (not shown). An estimated difficulty value and an estimated proficiency value are inferred (e.g., 210, 211, 303, 304, 307 and 308), for each data item, using Bayesian machine learning algorithms by the processor module 2120. The estimated values may refer to estimated values related to the labeling task or the vetting. Then, the processor module 2120 infers (e.g., 305, 312 and 212) a predicted uncertainty value of correctness of each data item. The predicted uncertainty value of correctness can refer to predicted uncertainty value of correctness of the labeling task or the vetting. The labels presenting the highest uncertainty values are then communicated to the trusted evaluator, optionally, through a network 2200 and a trusted evaluation of theses labels is received (e.g., 213 and 309). Additionally, a vetted evaluation value of correctness is received (e.g., 306) for the vettings presenting the highest uncertainty values. The depicted steps are repeated (e.g., 311 and 214) until the highest uncertainty value is below a threshold value. The highest predicted uncertainty value might be related to the predicted uncertainty values of the translation or it can refer to the predicted uncertainty values of vetting.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for improving quality of a dataset for which a labeling task is to be completed, the dataset comprising raw data items and, for each data item, one or more labels representing answers to the labeling task and, for each label, an associated labeler identifier, the method comprising:
repeating:
inferring, for each of the labeler identifiers in the dataset, an estimated proficiency value;
inferring a predicted uncertainty value of correctness of the label for at least a subset of the raw data items; and
receiving a trusted evaluation value of correctness for one or more labels of the subset of the raw data items for which the predicted uncertainty is inferred;
until the highest predicted uncertainty value in the dataset is below a threshold value.

2. The method of claim 1, further comprising inferring, for the labeling task to be completed, an estimated difficulty value.

3. The method of claim 1, further comprising requiring a trusted evaluation for each label of a subset of labels having associated therewith the highest predicted uncertainty values.

4. The method of claim 2, further comprising replacing a portion of the subset of labels having associated therewith the highest predicted uncertainty values with random labels of the dataset prior to requiring the trusted evaluation.

5. The method of claim 1, further comprising inserting into the dataset the trusted evaluation of each label for which the trusted evaluation is received.

6. The method of claim 1, further comprising completing computing until financial resources or time resources are exhausted.

7. The method of claim 1, further comprising communicating a subset of labels associated to a subset of data items to trusted evaluators.

8. The method of claim 1, further comprising quantifying proficiency of a labeler by computing correctness evaluation from experts compared to an initial submission from the labeler.

9. The method of claim 1, wherein crowd-sourced vetting is combined with trusted vetting to improve the quality of the dataset.

10. A labeling system configured for improving quality of a dataset, stored in a storage system, for which a task is to be completed, the dataset comprising raw data items and, for each data item, one or more labels representing an answer to the task and, for each label, an associated labeler, the labeling system comprising:
a memory module for storing a running list of items being labeled;
a processor module configured to repeatedly:
infer, for each of the labeler identifiers in the dataset, an estimated proficiency value;
infer a distribution for the degree of randomness in the correctness of the labels;
infer at least one predicted uncertainty value of correctness of the label for at least a subset of the raw data items; and
receive a trusted evaluation value of correctness for one or more labels of the subset of the raw data items for which the predicted uncertainty is inferred;
until the highest uncertainty is below a threshold value.

11. The labeling system of claim 10, wherein the processor module is further for inferring, for the labeling task to be completed, an estimated difficulty value.

12. The labeling system of claim 10, wherein the processor module is further for selectively requiring a trusted evaluation for each label of a subset of labels having associated therewith the highest predicted uncertainty values.

13. The labeling system of claim 11, wherein the processor module is further for replacing a portion of the subset of labels having associated therewith the highest predicted uncertainty values with random labels of the dataset prior to requiring a trusted evaluation.

14. The labeling system of claim 10, wherein the processor module is further for inserting into the dataset the trusted evaluation of each label for which the trusted evaluation is received.

15. The labeling system of claim 10, further comprising a network interface module for interfacing with a plurality of remote trusted evaluators.

16. The labeling system of claim 10, further comprising a network interface module for communicating a subset of labels associated to a subset of data items to trusted evaluators.

17. The labeling system of claim 10, further comprising a network interface module for communicating trusted evaluation of labels associated to raw data items to the processor module.

18. The labeling system of claim 10, wherein the processor module completes computing until financial resources or time resources are exhausted.

19. The labeling system of claim 10, wherein the processor module is further for quantifying proficiency of a labeler by computing correctness evaluation from experts compared to an initial submission from the labeler.

20. The labeling system of claim 10, wherein the processor module is further for combining crowd-sourced vetting with trusted vetting to improve the quality of the dataset.
